(19) United States
(12) Patent Application Publication
(10) Pub. No.: US 2011/0073386 A1
(43) Pub. Date: Mar. 31, 2011

(54) Climbing Robot Using Pendular Motion

(76) Inventor: William R. Provancher, Salt Lake City, UT (US)

(21) Appl. No.: 12/992,859

(22) PCT Filed: May 13, 2009
(86) PCT No.: PCT/US2009/043801

§ 371 Date: Nov. 15, 2010

Related U.S. Application Data
(60) Provisional application No. 61/053,267, filed on May 15, 2008.

(51) Int. Cl. B25J 5/00; B25J 15/00

(52) U.S. Cl. 180/7.1

(57) ABSTRACT

A climbing robot suitable for climbing a substantially vertical, inclined or horizontal surface comprises a main body (14) including: an upper cross-member (18) having a pair of ends; and a pair of spaced-apart gripping mechanisms (16a, 16b) coupled to the main body. The pair of gripping mechanisms are independently and selectively releasable from and attachable to a surface on which the robot can climb. An actuator (40) is carried by the main body, and an end-weighted pendular tail (12) is actuatable by the actuator and is configured for pendular rotation relative to the main body. Rotation of the pendular tail relative to the main body causes one end of the cross-member main body to rise relative to an other end of the main body resulting in the robot climbing the surface.

### FIELD OF THE INVENTION

The present invention relates to mobile robots capable of climbing substantially vertical, inclined or horizontal surfaces.

### BACKGROUND OF THE INVENTION AND RELATED ART

Mobile robots can be designed to work in hazardous, challenging or even hostile environments where the risk of human injury is high. Significant progress has been made by small ground traversing robots for traveling over rough terrain and performing surface-related tasks, such as remote surveillance, bomb disposal, etc. Shear or near-vertical surfaces are another challenging environment for mobile robots, where it is anticipated that climbing robots can be used to perform inspection, clearing, maintenance, service, and surveillance, etc. Unfortunately, climbing robots face a variety of challenges distinct from those faced by ground traversing robots, such as the need to fully lift their entire mass in order to make vertical progress (as in the case of ‘pull-up’ style climbers), holding onto the vertical surface, maneuvering laterally or over/around surface features, and self-orienting in the vertical plane.

To overcome these obstacles, existing climbing robots have been equipped with a variety of mechanical actuation devices to improve attachment the vertical surface and to facilitate their climbing strategies. For example, mechanisms used to hold on to or grip vertical surfaces include suction systems, directional adhesives, magnets and gripping spines, while systems used to move about in a shear or near-vertical environment include wheels, tracks, actuated arms, vacuum adhesion systems, pneumatically actuated systems, and cables. Many of these prior art climbing robots are simply adaptations of ground traversing robots with tracked or wheeled surfaces which have been modified to grip the vertical surface, but which maneuver over the vertical surface in the same manner as they would over ground.

In recent years, climbing robots have become lighter and more adaptable to a wide variety of surfaces, as well as more sophisticated in their functional capabilities. These advances have been driven by improved manufacturing techniques, lighter and stronger materials or composites, and increased microcontroller computational power. However, as demonstrated by their limited penetration into a high-value market, present-day climbing robots have as yet experienced only modest success.

### SUMMARY OF THE INVENTION

In light of the problems and deficiencies inherent in the prior art, the climbing robot of the present invention seeks to overcome these by implementing hybrid climbing strategies inspired by observation of the natural world. For instance, proficient human climbers take advantage of both subtle and dramatic mass shifting to gain elevation with minimal physical effort. A simple lateral body movement prior to changing handholds often enables a human climber to reach higher with less pull-up effort. Furthermore, human climbers often engage in dramatic mass shifting in preparation for highly dynamic climbing motions, essentially winding-up and then releasing their potential energy (PE) to make large vertical gains.

Brachiation is a form of movement most notably employed by gibbons when they swing from one handhold to the next in a very dynamic pattern of gripping and swinging. Brachiative motion strings together a sequence of pendular paths with coordinated grip changes to achieve lateral motion. In this method of lateral swinging motion, very little input energy is required to maintain physical progress.

The climbing robot of the present invention turns standard gibbon brachiation on its side to produce vertical translation, and combines it with a human-style mass shifting to form a hybrid, tail-swinging body oscillating climbing strategy. The robot is a pendular two-link, serial chain robot that utilizes alternating hand-holds and an actuated tail to propel itself upward, The robot's climbing strategy includes a variety of climbing gaits which use precise mass shifts affected by carefully controlled and timed pendular tail motions to raise one hand of the robot at a time. As can be appreciated with pendular dynamics, maximum efficiency can be achieved by targeting the natural frequency of the system. Combining and integrating the strategies employed by both human climbers and animals, moreover, allows a climbing robot with a simple mechanical design and with a minimum of moving parts to employ a mass-shifting climbing strategy that is very energy efficient and enables a wide range of climbing gaits to suit different surfaces, tasks, and power or weight requirements.

In accordance with one aspect of the invention, a climbing robot suitable for climbing a substantially vertical, inclined or horizontal surface is provided, including: a main body including: an upper cross-member having a pair of ends; and a pair of gripping mechanisms spaced-apart and coupled to the main body. The pair of gripping mechanisms can be independently and selectively releasable from and attachable to a surface on which the robot can climb. An actuator can be carried by main body, and a weighted pendular tail can be actuatable by the actuator and can be configured for pendular rotation relative to the main body. Rotation of the pendular tail relative to the main body causes one end of the main body and associated gripper to rise relative to an other end of the main body and the other gripper, resulting in the robot climbing the surface.

In accordance with another aspect of the invention, a method of manipulating a climbing robot to climb a substantially vertical, inclined or horizontal surface is provided, comprising: obtaining a two-link climbing robot. The climbing robot can comprise: a main body including: an upper cross-member having a pair of ends; and a pair of gripping mechanisms spaced-apart and coupled to the main body, the pair of gripping mechanisms being independently and selectively releasable from and attachable to a surface on which the robot can climb; an actuator carried by main body; and a weighted pendular tail, actuatable by the actuator and being configured for pendular rotation relative to the main body. The method can include releasing from the surface a first of the pair of gripping mechanisms to allow a free end of the main body to rotate about a second, fixed gripping mechanism; rotating the pendular tail with the actuator to cause the free end of the main body to rise above the second gripping mechanism; and re-attaching the first gripping mechanism to the surface.

In accordance with another aspect of the invention, a method of directing a climbing robot to scale a substantially vertical, inclined or horizontal surface is provided, including: providing a pendulum actuated robot having a pendulum momentum transfer member (the robot's tail) and at least two spaced-apart gripping mechanisms; shifting the pendulum momentum transfer member while alternately attaching and releasing the at least two gripping mechanisms in a manner sufficient to cause alternating free and secured ends of the robot to rise.

In accordance with another aspect of the invention, a method of directing a climbing robot to move laterally is provided, comprising: providing a pendulum actuated robot having a pendulum momentum transfer member (the robot's tail) and at least two gripping mechanisms; shifting the pendulum momentum transfer member while alternately under- or over-rotating the robot to achieve a net lateral motion accompanied by forward or backward motion; and

shifting the pendulum momentum transfer member while alternately attaching and releasing the at least two gripping mechanisms in a manner sufficient to cause alternating free and secured ends of the robot to rise while laterally shifting the body of the robot. The under- or over-rotating can be caused by modifying the tail motion trajectory or by modifying the robot's mass properties using a moveable ballast (e.g. fluid held in small holding cells).

In accordance with another aspect of the invention, a method of directing a climbing robot to move laterally is provided, comprising: a pendulum actuated robot having a pendulum momentum transfer member and at least two gripping mechanisms; where the pendulum momentum transfer member (the robot's tail) is capable of a full 360 degrees of rotation, such that the robot's upper cross member can rotate to a near vertical orientation using alternating hand holds to pivot the robot's upper body to the right or left, as desired. The robot may also continuously rotate its tail while exchanging hand holds to move hand-over-hand to the left or right, as desired.

### BRIEF DESCRIPTION OF THE DRAWINGS

Features and advantages of the invention will be apparent from the detailed description that follows, and which taken in conjunction with the accompanying drawings, together illustrate features of the invention. It is understood that these drawings merely depict exemplary embodiments of the present invention and are not, therefore, to be considered limiting of its scope. And furthermore, it will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings, in which:

FIG. 1 illustrates a perspective view of a climbing robot using pendular motion, according to an exemplary embodiment of the present invention;

FIG. 2 illustrates a front view of the embodiment of FIG. 1, wherein the overlayed circles indicate the lumped mass representation used in numerical simulations of the robot's dynamic climbing behavior;

FIG. 3 illustrates the activity steps taken in performing a Static Climbing Gait, according to an exemplary embodiment of the present invention that possesses grippers or gripping mechanisms capable of multi-directional adhesion;

FIG. 4 illustrates the activity step logic for the climbing gait of FIG. 3;

FIG. 5 illustrates the activity steps taken in performing a Simple Oscillator Climbing Gait, according to an exemplary embodiment of the present invention that possesses grippers or gripping mechanisms capable of multi-directional adhesion;

FIG. 6 illustrates the activity step logic for the climbing gait of FIG. 5;

FIG. 7a illustrates the activity steps taken in performing an oscillatory gait with sinusoidal tail motions, according to an exemplary embodiment of the present invention that possesses grippers capable of uni-directional adhesion that can automatically release each gripper from a wall or surface when it no longer bears vertical forces. In this aspect of the invention, quasi-static robot motion results when the tail motion is driven at frequencies below resonance;

FIG. 7b illustrates the activity steps taken in performing an oscillatory gait with sinusoidal tail motions, according to an exemplary embodiment of the present invention that possesses grippers capable of uni-directional adhesion that can automatically release each gripper from a wall or surface when it no longer bears vertical forces. In this aspect of the invention, resonant robot climbing motion results when the tail motion is driven at frequencies near resonance;

FIG. 8a illustrates a magnetic gripping mechanism capable of multi-directional adhesion, according to an exemplary embodiment of the present invention;

FIG. 8b illustrates a dactyl claw gripping mechanism capable of providing uni-directional adhesion, according to an exemplary embodiment of the present invention.

FIG. 9a illustrates an embodiment that utilizes a pinion gear on a motor or other actuator to engage the drive gear on the tail: this aspect is representative of other non-direct drive strategies that can be utilized in the invention, such as a capstan, linkage mechanism, or timing belt driven tail transmission;

FIG. 9b illustrates an embodiment that utilizes a pinion gear on the motor to engage the drive gear on the tail similar to FIG. 9a. This embodiment also utilizes a fixed U-shaped tail (also referred to herein as an arcuate rail) to limit or prevent the robot from rolling and pitching and hence promote more consistent gripper attachment;

FIG. 9c provides a detailed view of the center of the climbing robot of FIG. 9b, showing the main circuit board, tail transmission, and width-adjustable grippers or gripping mechanisms;

FIG. 10 illustrates an overall design concept for an embodiment that utilizes a 4-bar crank-rocker mechanism to drive the motions of the robot's tail that results in increased efficiency and mechanical robustness. Circles indicate the robot's grippers and/or lumped masses used in dynamic simulation models; and

FIG. 11 illustrates an optional wireless communications system for the climbing robot of the present invention. One present exemplary embodiment utilizes 2.4 GHz wireless transceivers to allow the climbing robot to be controlled remotely from a desktop or laptop PC and control software such as Matlab through an ordinary RS-232 serial port. Robot state information can be provided to a PC based controller, which can return control input to the robot's grippers and tail motor in a manner that can be carried out by a local microcontroller and amplifier circuitry.

### DETAILED DESCRIPTION OF EXEMPLARY EMBODIMENTS

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

In describing embodiments of the present invention, the following terminology will be used.

The singular forms “a,” “an,” and “the” include plural referents unless the context clearly dictates otherwise. Thus, for example, reference to “a hand” includes reference to one or more of such features and “engaging” includes one or more of such steps.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Amounts and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. This same principle applies to ranges reciting only one numerical value and should apply regardless of the breadth of the range or the characteristics being described.

As used herein, the term “about” means that dimensions, sizes, formulations, parameters, shapes and other quantities and characteristics are not and need not be exact, but may be approximated and/or larger or smaller, as desired, reflecting tolerances, conversion factors, rounding off, measurement error and the like and other factors known to those of skill. Further, unless otherwise stated, the term “about” shall expressly include “exactly,” consistent with the discussion above regarding ranges and numerical data.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, the term “free end” of a body is to be understood to refer to a portion of the body that is not attached (at least presently) to a surface on or over which a robot is climbing: the term “fixed end” of a body is to be understood to refer to a portion of the body that is attached (at least presently) to the surface on or over which the robot is climbing.

As used herein, the term “climb” can be used to describe motion of a robot in an upward or downward motion (e.g., robots described herein can both scale upward and scale downward on or across a surface).

When one or more ends of a robot or main body of a robot are discussed herein as being “raised” relative to another, it is to be understood that this results in movement of the end being raised in a direction in which the robot is traveling. For example, robots disclosed herein can “climb” horizontal surfaces: in this scenario, when one end is “raised” relative to another, the “raised” end is moved in the direction of travel of the robot, even though an elevation of the end may not change.

In the present disclosure, the term “preferably” or “preferred” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

Illustrated in FIGS. 1-11 are various exemplary embodiments of the present invention for a climbing robot that utilizes pendular motion. In general, the climbing robot is a pendular two-link, serial chain robot that utilizes alternating hand-holds and an actuated tail to propel itself upward (or downward, or in a lateral direction, etc.) in a climbing style based on observations of human climbers and brachiating gibbons. Among other applications, the climbing robot can be used for autonomous surveillance, inspection and maintenance on sheer vertical surfaces.

The climbing robot's bio-inspired oscillating climbing strategy is simple and efficient, and employs a mass-shifting climbing protocol that enables a wide range of climbing gaits to suit different surfaces, tasks, and power or weight requirements. Moreover, the climbing strategy allows for a climbing robot having a simple mechanical design having a minimum of moving parts, particularly when compared to the various climbing robots existing in the prior art.

The climbing robot's No-inspired oscillating climbing strategy provides efficient climbing gaits, as it can alternately grip the wall with one gripping mechanism or hand at a time and swing its tail, causing a center of gravity shift or inertial mass shift that can raise its free hand, which can then grip the climbing surface at the top of the swing. The hands can swap gripping duties as the robot swings its tail in the opposite direction. As the robot's tail oscillates in pendular fashion from side to side, the resultant center of gravity changes to rotate the main body of the robot about the fixed or gripping hand. This rotation can then be coordinated with the gripping activity to drive the robot up a vertical surface.

As shown in FIG. 1, according to an exemplary embodiment of the present invention, the climbing robot can be a pendular two-link, serial chain robot with a pivoting, weighted tail attached to the bottom of an optionally T-shaped main body 14. Two gripping mechanisms (sometimes referred to herein as “grippers”) 16a, 16b can be carried by, or attached, adjacent each end of the main body's crossbar. In one specific design, an upper portion 18 of the T-shaped body can measure about 30.5 cm across, the swinging portion of the tail 12 can measure about 45.7 cm long, and the joint location “J” of the pendular, weighted tail can be adjustable such that it can be moved from 5-20 cm below the centerline between the robot's gripping mechanisms. Alternative designs may simply have a main body crossbar and no vertical body segment (e.g., the main body is simply bar-shaped). In one embodiment of this design, the body of the climbing robot can be about 30.5 cm×20.3 cm, while the tail can be about 45.7 cm long with tail mass. The gripping mechanisms can be attached at the right and left ends of the T-shaped body. In this particular embodiment, the total robot mass can be approximately 0.6 kg with a total body length of about 57 cm.

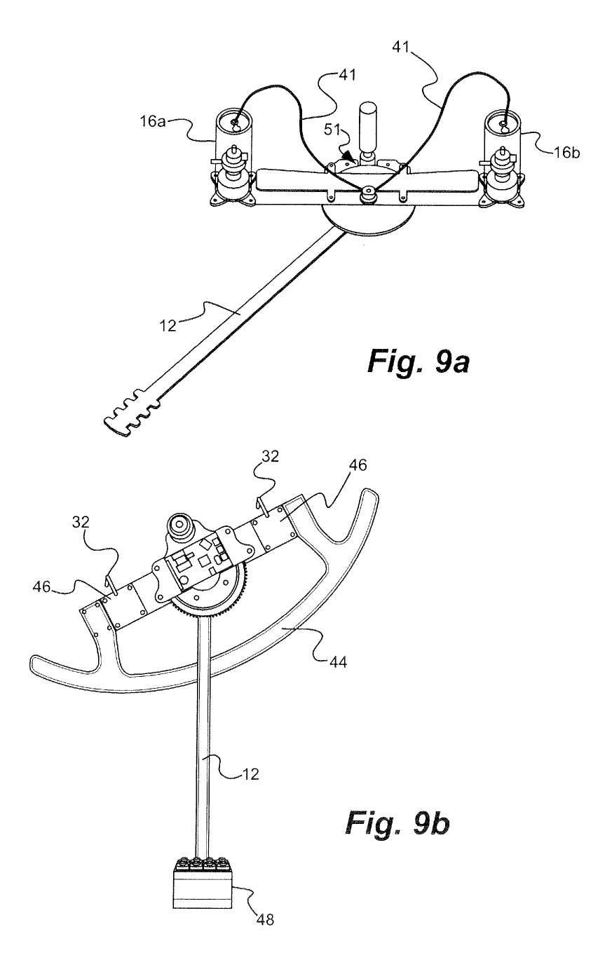

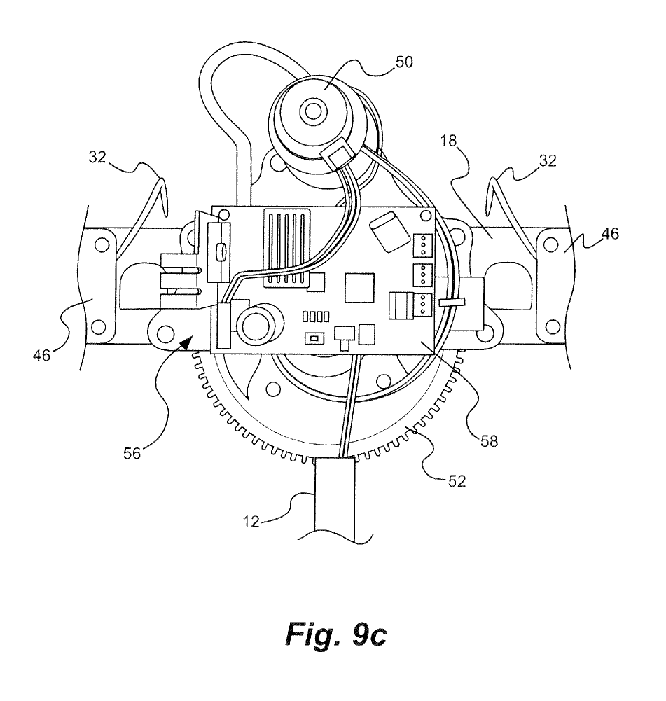

Generally speaking, the climbing robots of the present invention can incorporate encoders to measure body angle relative to or about the gripping mechanism or hand, as well as tail angle relative to the robot body. Encoder data can be used to implement control strategies. Furthermore, the climbing robot can be equipped with an IR rangefinder to help prevent collisions during climbing, and accelerometers attached to the robot can help compensate for sliding at the wall grips and sensor drift at the gripper encoders, and provide secondary position sensing for self-calibration or swing recovery. Motion control and sensor analysis can be performed using an onboard microcontroller or performed remotely on a PC with motion control software such as Matlab and communicated wirelessly as depicted in FIG. 11. The tail motor can be driven via an onboard motor amplifier or similar unit. Multiple climbing gaits and control strategies may be uploaded into the microcontroller at the same time and switched without requiring reprogramming; or even accomplished during mid-motion. Advantageously, the robot's batteries (48 in FIG. 9b) can be carried at the end of the tail 12, serving as a substitute for dead weight that would otherwise be required to be added at this location in order to produce the advantageous body torques, as the tail is swung, that are necessary to generate the climbing motion of the robot.

The gripping mechanism 16a, 16b shown in FIG. 1 can be configured to selectively, predictably and quickly engage and disengage the climbing surface. The body of the robot can also be configured to pivot about an engaged gripping mechanism in order to reach upward with its disengaged mechanism with sensors or encoders providing real-time data on the position of the robot's body about its engaged gripping mechanism.

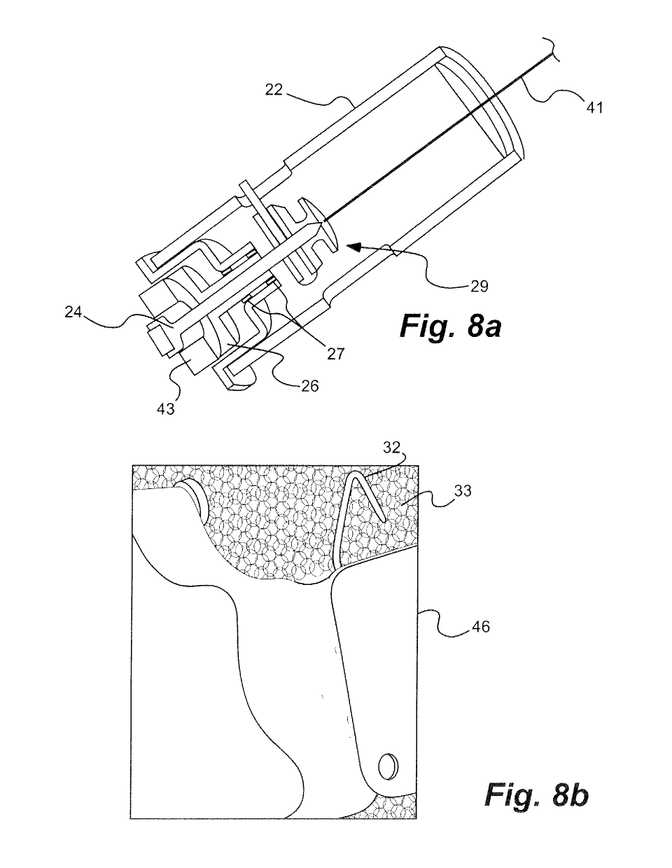

In an exemplary embodiment, the climbing robot of the present invention can be fitted with magnetic gripping mechanisms 22 (see, for example, FIG. 8a). This magnetic gripper design provides multi-directional adhesion. Alternately, suction cups and pressure sensitive adhesives, as well as other suitable multi-directional adhesives, can be made compatible with the robots of the present invention. The magnetic gripping mechanism 22 of FIG. 8a can include a magnet-tipped piston 24 that slides inside a bushing 26 located by bearings 27 within a radially symmetric column. An optical encoder 29 can be affixed to the piston to provide rotational position data of the body of the robot relative to the engaged gripping mechanism. A spring can drive the piston into the engaged position, while radio controlled (RC) hobby servos mounted to the body of the robot (e.g., 30a, 30b in FIG. 1) can pull the magnet-tipped pistons into the disengaged position via a cable 41. A friction ring 43, located peripherally to the magnet, can prevent the magnetic piston from sliding as the robot pivots about the attached gripping mechanism. Moreover, the robot's modular design can allow the substitution of a variety of gripping mechanisms designed to climb nonferrous surfaces, while still retaining the core functionality of the robot's oscillating climbing strategy. Variations on the magnetic gripping mechanism design shown in FIG. 8a can be utilized so as to require less actuation force to disengage the magnet from the ferrous climbing surface. One variation could incorporate magnetic gripping mechanism designs with internally balanced magnet forces by using springs to reduce the required forces for disengaging magnets from a ferrous surface, as reported by S. Hirose. Another variation of magnet gripper could utilize an array of smaller magnets that can be peeled one-by-one off the climbing surface, as reported by R. Fearing.

The magnetic gripping mechanisms can be particularly useful for experimentation and development purposes, such as refining the climbing strategies and logic and investigating energy efficiency. The magnetic gripping mechanisms can also provide optimum purchase on the many ferrous-based surfaces of interest for climbing robots, such as radio towers, skyscrapers, oil rigs, fluid storage vessels and tanks, process towers and ocean-going ships, etc.

In another embodiment, shown in FIG. 8b (also shown in FIGS. 9b and 9c), the robot utilizes dactyl claw gripping mechanisms 32 made of sharpened spring steel. The dactyl claw gripping mechanisms can be capable of providing uni-directional adhesion to grip the climbing substrate. This feature can be particularly advantageous in fibrous surfaces, such as carpet or wall coverings (e.g., 33 in FIG. 8b). This gripper type is termed unidirectional as it is engaged by sliding the claw's tip into the climbing surface, but releases automatically when the forces and/or motions on the claw is reversed (i.e., when tail reaction forces begin to drive that gripper upward). The use of a uni-directional gripping mechanism is a bio-inspired feature that can reduce the need for sophisticated sensing and control to coordinate the robot's motion with actuation of the grippers. Gecko-inspired dry adhesives are another example of uni-directional adhesives that are compatible with our robot's mechanical and controller designs.

As shown in FIGS. 9b and 9c, the dactyl claw grippers 32 can be coupled to the main body of the robot via clamping brackets 46. The clamping brackets can be adjustably coupled to the robot body to allow adjustment of a distance between the grippers (and/or adjustment of a distance from an end of the robot body).

Non-limiting examples of other exemplary non-magnetic gripping mechanisms can include suction systems, macrospine- and microspine-based designs, temporary adhesive, pressure sensitive or dry adhesives, surface tension-based devices, etc.

In the exemplary embodiment of FIG. 1, a motor 40 (which may utilize a gearhead) is used to directly drive the rotation of the weighted, pendular tail 12 around the lower portion of the T-shaped main body 18. However, a variety of means for rotating the weighted tail can be considered to fall within the scope of the present invention, such as a gear, linkage mechanism, timing belt/pulley, or capstan system where the motor is offset from the center of tail rotation to reduce the torque loadings on the drive motor and motor coupling, as shown at 51 in FIG. 9a. Furthermore, some of the energy used to rotate the tail can be stored in a mechanical spring, such as a clock spring mechanism, in compressed air, or provided by combustion or other sources located in the main body, so as to provide additional energy that augments or replaces the torque provided by the current drive motor when rotating the tail. The robot can also utilize a moveable ballast, not shown, (e.g. fluid held in small holding cells) to adjust the natural frequency of the robot to climb more efficiently over a range of different speeds.

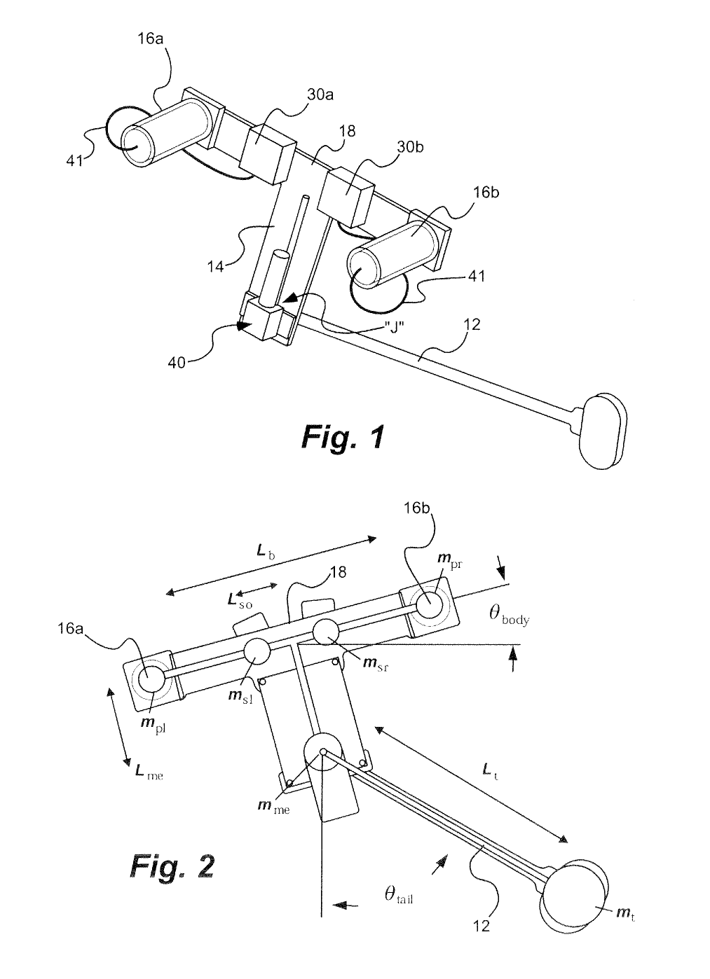

Illustrated in FIG. 2 is a front view of an exemplary embodiment of the climbing robot portraying the locations of masses for a lumped mass dynamic model that can be used to model the torques and lateral loading experienced by the climbing robot during operation. The illustration identifies the various dimensions and angles used to model and operate the robot, and is overlaid with exemplary mass distributions, where the masses shown can include: mₜ=300 g is tail mass, mₛₗ=22 g and mₛᵣ=22 g are left and right servo masses, m_{gl}=58 g and m_{gr}=58 g are left and right grip mechanism masses, m_{mc}=175 g is combined motor and electronics mass. The robot's dimensions for the embodiment shown in FIGS. 1 and 2 are overall body width, L_{b}=30.5 cm and tail length, Lₜ=45.7 cm long.

The climbing robot's configuration lends itself to a multiplicity of innovative climbing gaits that involve pendular motion, including, but not limited to the following gaits. The exemplary, specialized gaits can require or benefit from the use of multi-directional adhesives (e.g. as shown in FIG. 8a). One more related gait that can be utilized with uni-directional adhesives is later also described. The three climbing gaits compatible with multi-directional grippers, as identified and described below, can include Static, Simple Oscillator, and Swing-Up. The Simple Oscillator gait can be run quasi-statically at low frequencies and will elicit a more dynamic response as the tail frequency approaches resonance. The Swing-Up gait is a dynamic gait. For the sake of explaining the climbing logic in the next sections, the gripping mechanisms shall be referred to as “hands,” the body link shall be the “body,” and the tail link shall be the “tail.” The furthest that the tail can move from its zero position (perpendicular to a line between the robot's hands) positively, or negatively, shall be referred to as “moving the tail to the right, or left, side,” respectively.

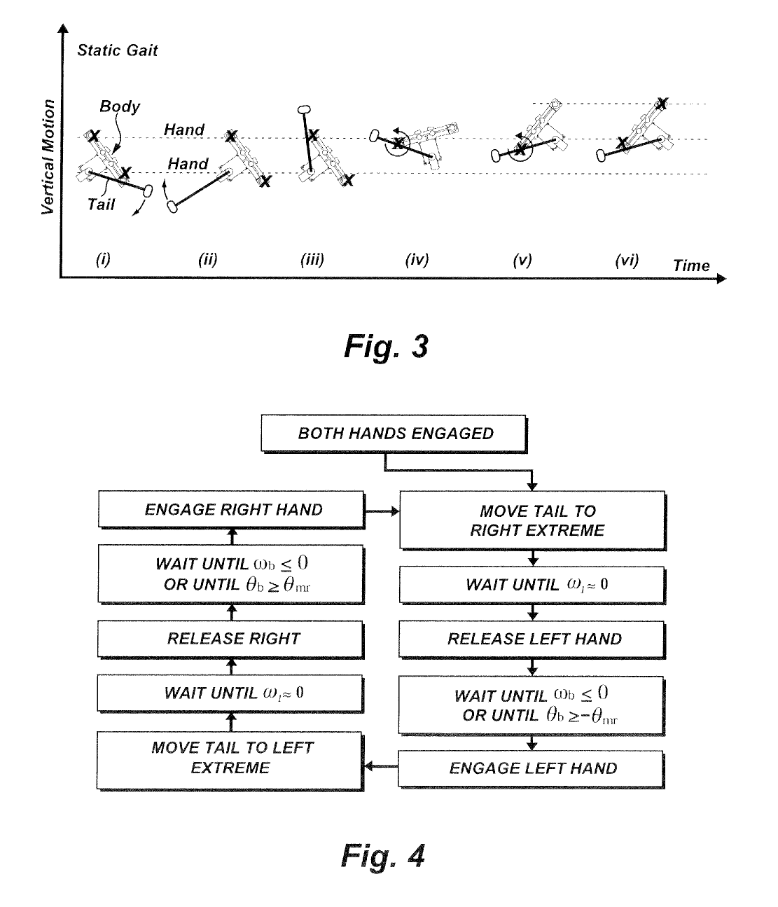

The Static gait, shown in FIG. 3, is the simplest of the gait strategies. In this case, both hands grip the wall while the tail swings to one side, either the left or the right side, as indicated in FIG. 3. This mass shifting provides the maximum offset of the climbing robot's center of gravity for maximum stored potential energy. Then, the hand that is furthest from the tail disengages the wall, providing a step release of the stored potential energy and corresponding angular step response. Ideally, the response of the robot is under-damped, which provides the climbing robot the maximum body swing due to overshoot per stored energy potential. During the swing phase, the tail position relative to the body is held constant, e.g. by locking the position. Upon attaining maximum vertical height of the free hand (i.e. maximum reach), the free hand also grips the wall and thus completes a single stride or half cycle. Next, the tail is driven to its opposite side while both hands grip the wall and the sequence is repeated to complete a full cycle.

This gait strategy requires the least time hanging onto the wall by only one hand and should give the climbing robot's disengaged hand the greatest static swing up per tail motion input (without being driven at resonance). However, since the robot must lift its tail orthogonal to the gravity, this gait requires higher torques and more energy input to the tail motor. This static gait can be the safest since both hands are simultaneously engaged on the surface throughout a majority of the gait. Further, this approach has the lowest reaction forces (e.g. most often less than about 1 ‘g’ of gravity force per gripper) at the surface such that lower adhesion force to the wall is necessary to keep the robot in place. However, torque at the tail link can be relatively high compared to other gait options making designs with mechanical advantage mechanisms external to the main motor being desirable over a directly driven tail in this embodiment. For example, one can use a gear-pulley system so the motor is not coincident with the axis of rotation for the tail while also lowering the torque experienced at the geared motor output shaft, as shown in FIGS. 9a, 9b, and 9c.

One particular embodiment of this feature is illustrated in FIG. 9c. In this aspect, the robot includes a motor/encoder 50 that is mechanically coupled (via conventional methods) to a tail gear 52. The tail gear is held by gear housing 56. A circuit board 58, of the type known by those of ordinary skill in the art having possession of this disclosure, can control all or most of the movement and/or sensing functions of the robot.

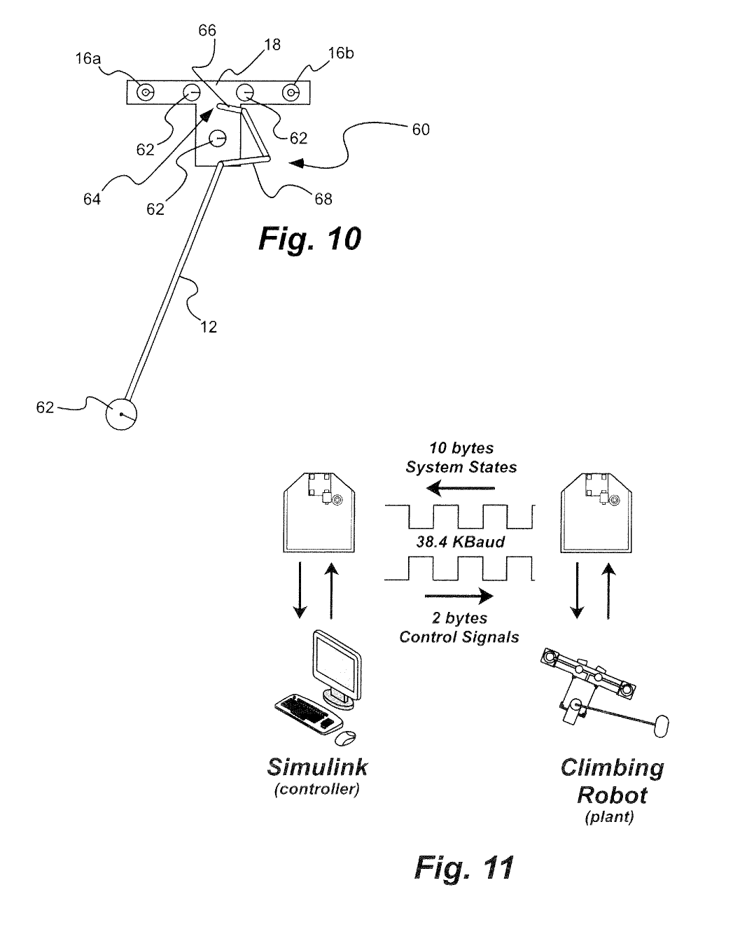

A linkage mechanism could also be utilized for the purpose of reducing torques at the motor output, as shown in FIG. 10. Such a linkage mechanism when used in combination with compliance placed in series with the linkage on the output of the motor or the rocker arm (or similar) also provides potential advantages for improved climbing efficiency and damage tolerance of the drive-train. In this embodiment, a 4-bar crank-rocker mechanism 60 can be utilized to drive the motions of the robot's tail 12 that results in increased efficiency and mechanical robustness. The motor 64, crank link 66, and rocker link 68 of the crank-rocker 4-bar mechanism are shown in FIG. 10. Markers 62 indicate lumped masses that can be used in dynamic simulation models.

Illustrated in FIG. 4 is the climbing logic that controls the Static gait, which is very simple: the tail is moved until a desired tail angular position is achieved, then a grip is released and remains released until a maximum body angular position θₘᵣ is achieved without flipping completely over at which point the free grip is engaged and the tail begins swinging in the opposite direction. This logic accurately reproduces the static gait yet has one added feature that ensures optimal climbing rate. The simulation logic limits the body swing up response to a maximum limit of θ_{body} which corresponds to the angle of maximum reach of the body per body swing, when the body has rotated vertically (see FIG. 2).

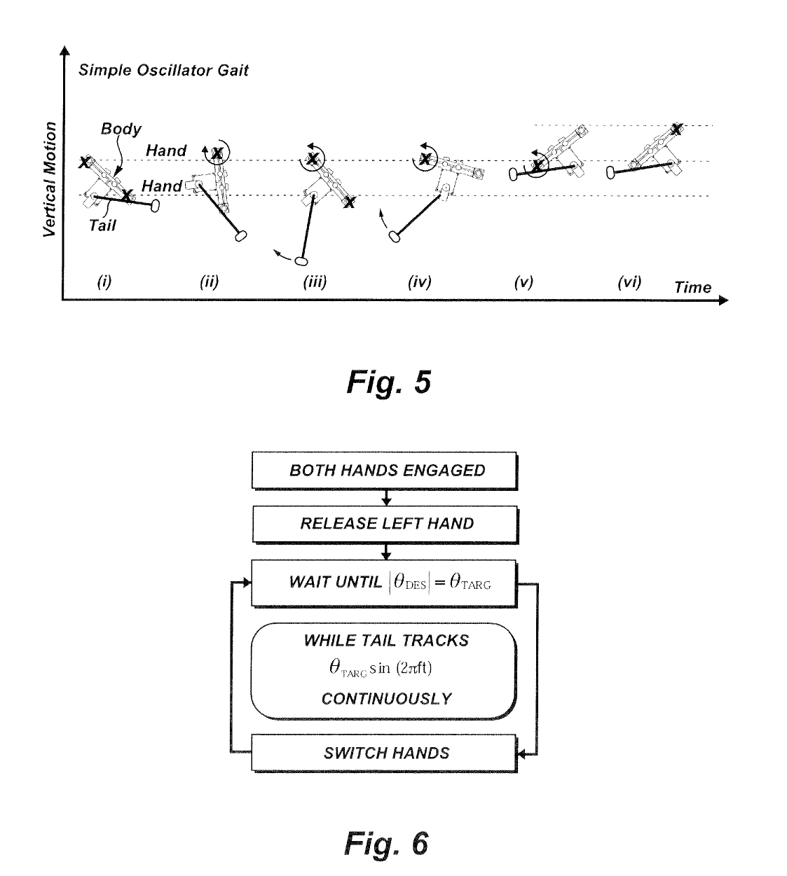

The Position-based Simple Oscillator (“Position SO”) Gait, shown in FIG. 5, uses a more continuous motion than the Static gait, inputting energy (via tail swinging or mass shifting) as the body swings about a single hand. In this strategy, the climbing robot begins from rest with a single hand holding the wall (assume the tail is limply hanging down). The tail is then commanded to steadily move towards a desired angular position that is closest to the engaged hand that is holding on to the wall. As the tail is slowly moved, the climbing robot's overall center of gravity shifts to maintain equilibrium of tail and body about the gripping hand. This mass shifting causes the free hand to steadily rise as the climbing robot pivots about its gripping hand. Upon attaining its maximum vertical reach, the climbing robot exchanges handholds, first holding onto the wall with the higher hand and then releasing the wall with its lower hand, completing one stride (a half-cycle). The robot then performs the same sequence with the sides switched to complete one cycle.

This gait can impart lower lateral loads to the magnets in the climbing robot's hands and can permit lighter weight gripping mechanisms to be used. Position SO may not allow the climbing robot to reach as high on each cycle as the Static gait since it is unlikely that there will be any overshoot of the robot past static equilibrium. However, this gait has the advantage that the tail never has to be lifted as high (orthogonal to gravity) for as long a time relative to the Static gait.

One variation on Position SO is the Frequency-Based Simple Oscillator (“Frequency SO”) Gait. The tail is still oscillated from left to right, but instead of constantly tracking an alternating angular position of the tail from left to right, the tail is given a specific sinusoidal trajectory to track at a prescribed frequency. When the tail's reference trajectory velocity reaches a zero value, a hand switch is instantiated. This operation is the same for both left-to-right hand switches as well as right-to-left hand switches. Note, that the control logic for the Frequency SO does not require the input of the climbing robot's body or tail states, only the position of the tail trajectory relative to the body. However, this gait controller may use external sensor information such as the body orientation based on gripper encoders, or an accelerometer on the body. The tail reference trajectory signal is used as a method of ensuring that hand exchanges occur at a specific frequency, hence avoiding any erratic climbing behavior that may occur if climbing were to be based off of any the climbing robot states.

Frequency SO begins with a single hand engagement and the tail being driven at a previously specified frequency. Once the tail reference signal changes direction, the climbing robot executes a hand switch to complete a single stride. The same logic is repeated for the remaining stride in the single climbing cycle. Note, that this gait also only requires sensor information from the tail encoder, used to maintain tail trajectory, which is also advantageous compared to the other climbing gaits. All other climbing gaits require knowledge of the body's angle with respect to gravity to determine the proper timing of wall grasping within each stride. This gait requires less torque for driving the tail than the Static gait thereby reducing the required tail motor size as well as the stress carried by the tail coupler. Although this gait has higher reaction forces at the hands compared to the Static Gait.

The climbing logic that controls the Frequency SO gait can be seen in FIG. 6. The desired tail reference signal can be tuned in terms of frequency and amplitude for the determination of optimal climbing parameters, e.g. operation at resonance for a second order system.

The Swing-Up gait (not shown) is an energy-based climbing strategy. In this strategy, the climbing robot attempts to maximize the climbing robot's potential energy (PE), and hence upward reach, of the climbing robot's free hand. The minimal PE point is considered to be when the free hand of the climbing robot's body hangs directly under the point of engagement and the maximal PE location is when the climbing robot's body link is 180 degrees from the minimal (essentially balancing directly on top of the gripping hand). As the body link is unactuated, this maximum PE position goal can only be accomplished by swinging the climbing robot's tail so as to promote the body response to grow in oscillation amplitude, i.e., ‘pumping’ PE into the system. This manner of tail motion is achieved by actuating the tail at maximum torque in the same direction as the velocity of the body until a physical tail motion constraint is encountered. The method is similar to the way in which a gymnast swings his/her legs to gain oscillation amplitude when on the rings or parallel bars. Thus, the Swing-Up gait begins with a single hand holding the wall. The climbing robot then swings its tail in the direction of the body's velocity until the body achieves a specified transition point; e.g., maximal PE position or a desired angle. Upon meeting this specified transition criterion, the robot exchanges hand holds and the higher/free hand grabs the wall, followed by lower hand releasing the wall, which marks the completion of a half cycle. Then the sequence of pumping energy is continued until the alternate hand reaches its maximum PE in order to complete a full cycle. This gait can first experience a period of oscillation that will later settle into steady-state climbing at a higher climbing rate than other quasistatic climbing gaits.

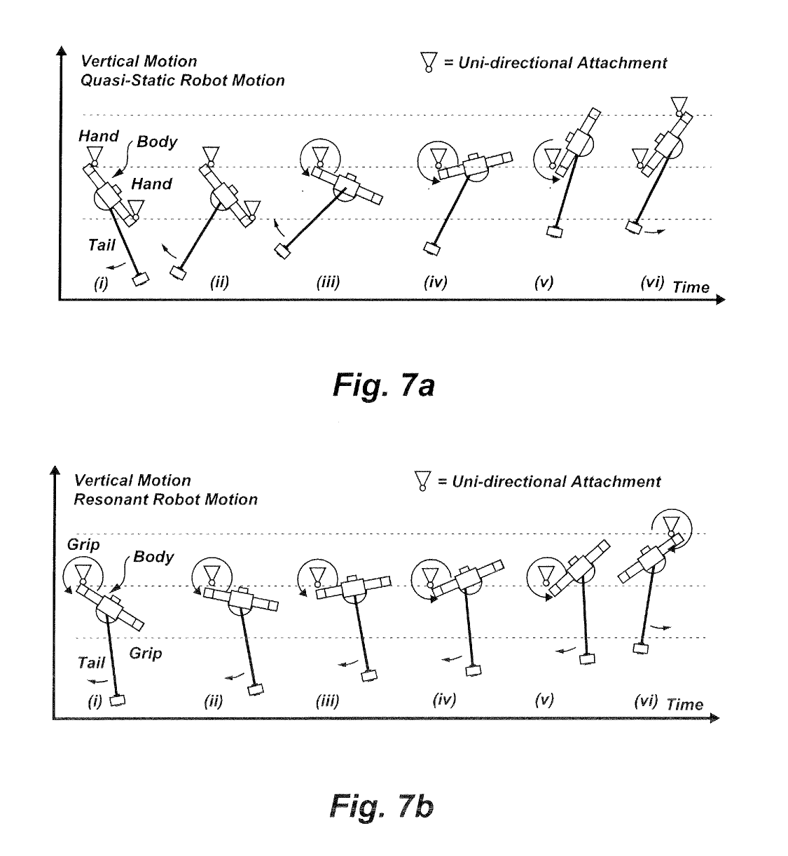

In the case where uni-directional adhesion grippers are utilized, the robot design and control thereof can be substantially simplified. One can drive the motion of the robot's tail in the same manner as the Frequency-Based Simple Oscillator (“Frequency SO”) Gait described above and in FIGS. 5 and 6. However, when uni-directional adhesion is used, there is no need to actuate or control the grippers. The robot's upper body (which can be a cross-bar) is simply constrained in a manner that only results in positive climbing motion (as a result of directional adhesion). FIG. 7a shows the resulting quasi-static robot motion when the tail motion is driven at frequencies below resonance. FIG. 7b shows resonant climbing motion that results when driving the tail at frequencies near resonance. By driving the robot at or near resonance, a substantial gain in efficiency can be achieved; however, climbing at resonance can also result in a reduced grip reliability due to highly dynamic and sometimes out-of-plane robot motions.

To mitigate issues with gripping reliability experienced when climbing near resonance, the robot can incorporate features to reduce the rolling and pitching motions of the robot that are excited at resonance. One such solution is the use of a U-shaped fixed tail (or arcuate rail) 44, as shown in FIG. 9b. This fixed tail can glide over the surface of the climbing substrate, like a sled, and reduce the pitch and roll of the robot. This leads to more consistent and reliable gripper engagement. Furthermore, such a tail could itself be actuated to allow the robot to selectively roll as needed for one of its feet to “step over” an obstacle.

Although the foregoing discussion focuses on substantially vertical motion, these same gaits and methods can also be applied to motion on non-vertical surfaces, e.g. lateral, inclined or flat. Similarly, the climbing robot can be allowed to scale down a vertical or inclined surface by alternately releasing the gripping mechanism and allowing gravity to accomplish downward motion. The downward motion can be optionally augmented by swinging of the tail. Lateral motion can be achieved by alternately under or over rotating the robot as it swings from right and left hand pivots, and repeating this motion to accomplish a net left or right motion accompanied by descent or ascent of the robot.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed and desired to be secured by Letters Patent is:

1. A climbing robot suitable for climbing a substantially vertical, inclined or horizontal surface comprising:
a main body including:
an upper cross-member having a pair of ends; and
a pair of spaced-apart gripping mechanisms coupled to the main body, the pair of gripping mechanisms being independently and selectively releasable from and attachable to a surface on which the robot can climb;
an actuator carried by the main body; and
a weighted pendular tail, actuatable by the actuator and being configured for pendular rotation relative to the main body;
wherein rotation of the pendular tail relative to the main body causes one end of the main body to rise relative to an other end of the main body resulting in the robot climbing the surface.

2. The climbing robot of claim 1, wherein rotating the pendular tail in a direction of a side opposite a free end of the main body causes the main body to pivot around a fixed end and raise the free end above the fixed end.

3. The climbing robot of claim 1, wherein rapidly rotating the pendular tail in a direction of a free end of the main body causes the main body to pivot around the fixed end and raise the free end above the fixed end.

4. The climbing robot of claim 1, wherein the pair of gripping mechanisms include a magnetic interface for engaging a ferrous surface.

5. The climbing robot of claim 1, wherein the pair of gripping mechanisms are operable to selectively engage and disengage a non-ferrous surface.

6. The climbing robot of claim 1, wherein the pair of gripping mechanisms include vacuum suction cups suitable for engaging a relatively smooth surface.

7. The climbing robot of claim 1, wherein the actuator is selected from the group consisting of: a motor, a gear train, a linkage mechanism, a capstan, one or more belts, a cable system to pull laterally on the tail, and an energy storage device including one or more of a mechanical spring, compressed air, or a combustion device.

8. The climbing robot of claim 7, wherein the actuator includes a linkage, and wherein the linkage is associated with a compliance device arranged in series with the linkage and the actuator to provide improved climbing efficiency and damage tolerance of the drive train.

9. A method of manipulating a climbing robot to climb a substantially vertical, inclined or horizontal surface comprising:
obtaining a two-link climbing robot comprising:
a main body including:
an upper cross-member having a pair of ends; and
a pair of spaced-apart gripping mechanisms coupled to the main body, the pair of gripping mechanisms being independently and selectively releasable from and attachable to a surface on which the robot can climb;
an actuator carried by main body; and
a weighted pendular tail, actuatable by the actuator and being configured for pendular rotation relative to the main body;
releasing from the surface a first of the pair of gripping mechanisms to allow a free end of the main body to rotate about a second, fixed gripping mechanism;
rotating the pendular tail with the actuator to cause the free end of the main body to rise above the second gripping mechanism; and
re-attaching the first gripping mechanism to the surface.

10. The method of claim 9, further comprising:
attaching the second gripping mechanism to the surface;
releasing the first gripping mechanism from the surface; and
rotating the pendular tail to cause the robot to climb.

11. The method of claim 9, further comprising releasing one of the pair of gripping mechanisms, rotating the pendular tail and re-attaching the gripping mechanism in accordance with a Simple Oscillator Gait climbing strategy.

12. The method of claim 9, wherein the gripping mechanisms comprise uni-directional adhesive grippers, and further comprising rotating the pendular tail in accordance with a Frequency-based Simple Oscillator Gait.

13. The method of claim 9, further comprising rotating the pendular tail, releasing one of the pair of gripping mechanisms and re-attaching the gripping mechanism in accordance with a Swing-Up Gait climbing strategy.

14. (canceled)

15. (canceled)

16. A method of directing a climbing robot to move laterally, comprising:
providing a pendulum actuated robot having a pendulum momentum transfer member and at least two gripping mechanisms, wherein the pendulum momentum transfer member is capable of a full 360 degrees of rotation;
rotating the pendulum momentum transfer member to cause a main body of the robot to rotate to a nearly vertical orientation while alternately attaching and releasing the gripping mechanisms to alternately pivot the robot's main body to move the robot to the right or to the left.

17. The method of claim 16, wherein rotating the pendulum momentum transfer member comprises substantially continuously rotating the pendulum momentum transfer member while alternately attaching and releasing the gripping mechanisms to continuously pivot the robot's main body clockwise or counter-clockwise to move the robot to the left or to the right.

18. A device of claim 1, wherein the climbing robot includes at least one wireless transceiver operatively connected thereto via an on-board microcontroller having control software encoded thereon, and further comprising communicating sensor state information to an associated computer via wireless transceivers, wherein the computer performs controls computations and wirelessly returns to the robot control efforts and actions to be carried out by the robot's on-board microcontroller and motor amplifier.

19. A device of claim 1, wherein the robot includes an arcuate rail suspended therefrom to aid in controlling roll and/or pitch orientation of the robot relative to the climbing substrate to provide more consistent gripping mechanism attachment and/or obstacle avoidance.

20. A device of claim 1, further comprising a moveable ballast associated with the robot to enable lateral steering motion or adjustment of the natural frequency of the robot to climb more efficiently over a range of different speeds.
